(19) United States
(12) Patent Application Publication
(10) Pub. No.: US 2013/0146516 A1
(43) Pub. Date: Jun. 13, 2013

(54) AUTOMATIC OZONE WATER OUTPUT DEVICE

(71) Applicant: CASHIDO CORPORATION, HSINCHU COUNTY (TW)

(72) Inventors: SHIH-CHANG CHEN, HSINCHU COUNTY (TW); YUAN-PENG LEE, HSINCHU COUNTY (TW); PO-HUNG LAI, HSINCHU COUNTY (TW); HSIU-LI WEN, HSINCHU COUNTY (TW); LING-HUI LU, HSINCHU COUNTY (TW)

(73) Assignee: CASHIDO CORPORATION, HSINCHU COUNTY (TW)

(21) Appl. No.: 13/762,675

(22) Filed: Feb. 8, 2013

Related U.S. Application Data
(63) Continuation-in-part of application No. 12/852,691, filed on Aug. 9, 2010.

(30) Foreign Application Priority Data
Aug. 14, 2009 (TW) 98214965

(51) Int. Cl. C02F 1/78

(52) U.S. Cl. CPC C02F 1/78
USPC 210/143; 210/192

(57) ABSTRACT

An automatic ozone water output device comprises a water supply system, a negative pressure mixing element, and an ozone generating assembly. The water supply system is connected to a water source. The negative pressure mixing element is installed on the water supply system and has at least one flow channel. The ozone generating assembly has a sound sensor and an ozone generator, wherein the sound sensor is in connection with an air source for detecting a sound level of airflow, one end of the ozone generator is in connection with the sound sensor, the other end of the ozone generator is in connection with the negative pressure mixing element. Specially, the negative pressure mixing element is configured in such a way that when water flows through the flow channel, negative pressure is generated to produce an absorbing force to mix ozone into water.

### REFERENCE TO RELATED APPLICATION

This application is a Continuation-in-Part of application Ser. No. 12/852,691, filed Aug. 9, 2010, and entitled AUTOMATIC OZONE OUTPUT DEVICE, currently pending.

### BACKGROUND OF THE INVENTION

1. Field of the Invention

The present invention relates to an automatic ozone water output device with at least one water inlet tube. More particularly, the present invention provides an ozone generator for use in such a device which is easily and quickly disassembled for cleaning.

2. Description of Related Art

Ozone (O₃) is a highly active and unstable gas, and is easily combinable with positive ions to generate un-harmful chemical compounds. Because objects or microorganisms that are harmful for people health usually possess positive ions, ozone can effectively oxidize them on contact to neutralize the harmful objects. Moreover, the solubility of ozone is remarkably high. Thus, ozone has been a popular cleaning agent for decades. Currently, numerous cleaning equipments are taking advantage of the cleaning power of ozone; such devices include washing machines, refrigerators, air-conditioners, and air-cleaning machines, etc.

The principle for generating ozone is simple, as ozone in the nature environment is generated by the discharging of lightning in the atmosphere. Industrially, one method of generating ozone comprises guiding air into a chamber between two electric poles through a high voltage discharging process. The oxygen molecules that pass through the electric poles are excited and thus spilt into individual oxygen atoms. The oxygen atoms are then combined with surrounding oxygen molecules to form ozone. Because the principle of the ozone generators is simple, ozone generators have been well developed and applied to a wide range of sanitation equipments.

Since ozone possesses excellent disinfecting and deodorizing properties, it is naturally logical to install ozone generators in public environments; the phagocytic property of ozone makes it a beneficial choice for use in the public water supply system to improve public hygiene, particularly in the public water faucet equipments.

However, the development emphasis of public faucet equipments has been placed on the conservation of power and water, or merely the appearance of the faucet unit; the ability to provide additional sanitary functions has traditionally not been a concern. Also, an externally mounted ozone generator unit, such as the one disclosed in U.S. Patent Publication No.: 2006/0266683, would not only hinder the esthetic appearance of the public facilities, the exposing unit would more likely suffer damage from accidental/intentional abuse from the general public.

Therefore, it is desirable to provide a simple and durable ozone water generating machine that can be easily and concealedly installed in various public environments to improve the quality of water supply.

### SUMMARY OF THE INVENTION

The objective of the present invention is to provide an automatic ozone water output device that automatically adds ozone to water in public places. Moreover, the automatic ozone water output device is durable and requires low maintenance, thus making this device ideal for improving public hygiene.

Another objective of the present invention is to provide an automatic ozone water output device whose structure is simple, installation process is easy, is not easily damaged, has a long life expectancy, and has low maintenance cost.

In order to achieve the aforementioned objectives, according to an embodiment of the present invention, an automatic ozone water output device comprises a water supply system, a negative pressure mixing element, and an ozone generating assembly. The water supply system is connected to a water source. The negative pressure mixing element is installed on the water supply system and has at least one flow channel. The ozone generating assembly has a sound sensor and an ozone generator, wherein the sound sensor is in connection with an air source for detecting a sound level of airflow, one end of the ozone generator is in connection with the sound sensor, the other end of the ozone generator is in connection with the negative pressure mixing element. Specially, the negative pressure mixing element is configured in such a way that when water flows through the flow channel, negative pressure is generated to produce an absorbing force to mix ozone into water.

In order to further the understanding regarding the present invention, the following embodiments are provided along with illustrations to facilitate the disclosure of the present invention.

### BRIEF DESCRIPTION OF THE DRAWINGS

FIG. 1 shows a schematic diagram of the automatic ozone water output device, according to the first embodiment of the present invention;

FIG. 2 shows a schematic diagram of the operation principle of the ozone generating assembly, according to the first embodiment of the present invention;

FIG. 3 shows a schematic diagram of the operation principle of the negative pressure mixing element, according to the first embodiment of the present invention.

FIG. 4 shows a schematic diagram of the automatic ozone water output device, according to the second embodiment of the present invention;

FIG. 5 shows a exploded diagram of the negative pressure mixing element according to the second embodiment of the present invention; and

FIG. 6 shows an assembled diagram of the negative pressure mixing element according to the second embodiment of the present invention.

### DETAILED DESCRIPTION OF THE PREFERRED EMBODIMENTS

The aforementioned illustrations and following detailed descriptions are exemplary for the purpose of further explaining the scope of the present invention. Other objectives and advantages related to the present invention will be illustrated in the subsequent descriptions and appended drawings.

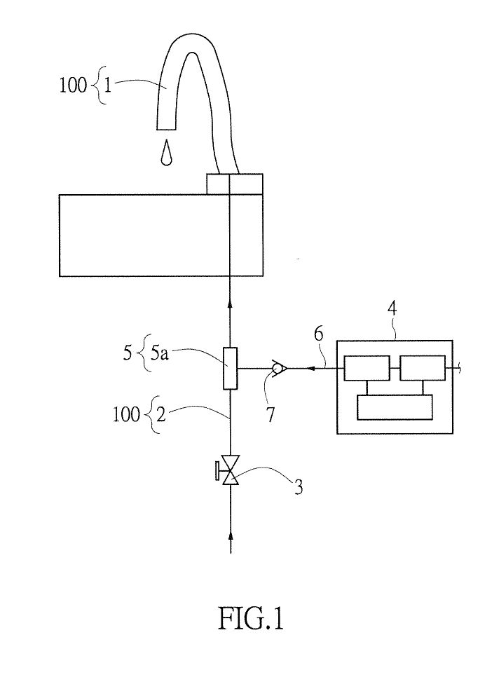

Reference is made to FIG. 1, which shows a schematic diagram of the automatic ozone water output device. The automatic ozone water output device comprises a water supply system 100, ozone generating assembly 4, and a negative pressure mixing element 5, wherein the water supply system 100 for directing water to drain properly is composed of two parts, a sensor faucet 1 and at least one water inlet pipe 2.

The sensor faucet 1 may sense the presence of a user by using infrared rays, or static capacitor etc. The water inlet pipe 2 may be a conventional water pipe for connecting a water source with the sensor faucet 1. Furthermore, an electromagnetic valve 3 is disposed on the water inlet pipe 2 in conjunction with the sensor faucet 1, and a negative pressure mixing element 5 is disposed on the water inlet pipe 2 of the water supply system 100 to form a venturi section. When the sensor faucet 1 detects the presence of a user, the electromagnet valve 3 is turned on to allow water to flow through the water inlet pipe 2. The ozone generating assembly 4 is arranged in a concealed space or other sheltered locations, such as the area under a basin and a sink. Moreover, the ozone generating assembly 4 can be activated to start generating ozone under a pressure drop when water flows through the venturi section of the water inlet pipe 2.

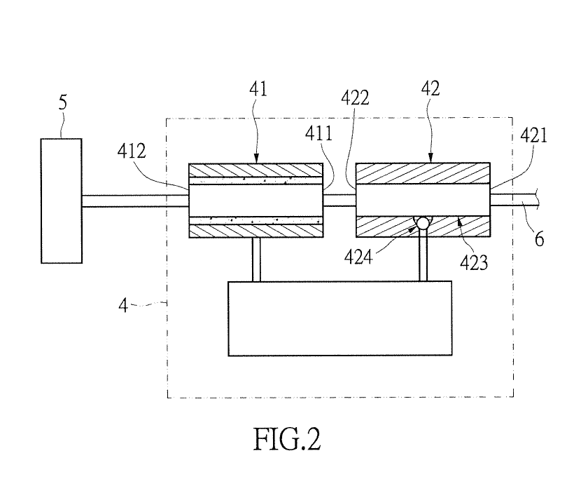

Please refer to FIGS. 1 and 2. Concretely speaking, the ozone generating assembly 4 includes an ozone generator 41, a sound sensor 42, and a microchip controller 43. The ozone generator 41 has an air inlet 411 formed thereon and an air outlet 412 away from the air inlet 411, wherein the air inlet 411 is in connection with the sound sensor 42, the air outlet 412 is in connection with the negative pressure mixing element 5. The sound sensor 42 is in connection with an air source through an air inlet pipe 6. The ozone generator 41 and the sound sensor 42 are electrically connected to the microchip controller 43.

The sound sensor 42 has an air inlet 421 formed thereon, an air outlet 422 away from the air inlet 421, and an air channel 423 between the air inlet 421 and the air outlet 422 for directing airflow. The air inlet 421 of the sound sensor 42 is in connection with the air inlet pipe 6, and the air outlet 422 of the sound sensor 42 is in communication with the air inlet 411 of the ozone generator 41. The sound sensor 42 further includes a sound sensing element 424, which is detachably arranged on one side of the air channel 423 for convenient maintenance if necessary.

Specially, when water flows through the negative pressure mixing element 5, negative pressure is generated by the venture effect to produce an absorbing force so that air will pass through the air inlet pipe from the air source to the ozone generator 41. As the same time, the sound sensor 42 detects the sound level of the airflow and then transmits the sound signal to the microchip controller 43. Thereby, the microchip controller 43 will compute and then active the ozone generator 41 to generate ozone by a process such as high-pressure discharge when the sound energy exceeds a predetermined value.

In one preferred embodiment, the automatic ozone water output device further comprises a reverse-stopping valve 7 (as shown in FIG. 1). The reverse-stopping valve 7 is disposed on the air inlet pipe 6 which is in communication with the ozone generating assembly 4 and the negative pressure mixing element 5 respectively to prevent water from flowing back to the ozone generating assembly 4.

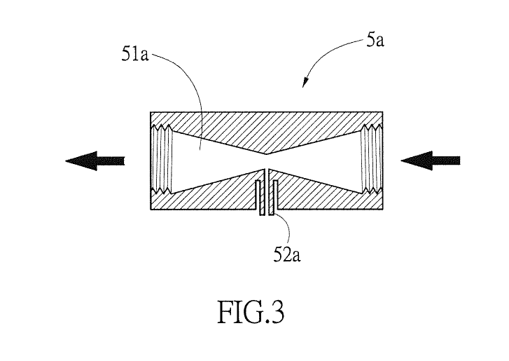

Please refer to FIG. 3. The negative pressure mixing element 5 is a venturi pipe 5a having a flow channel 51a that both ends are wide and the middle portion is narrow and a manifold 52a extending from the narrow middle portion. When water flows through the flow channel 51a, negative pressure is created at the narrow middle portion of the flow channel 51a. The negative pressure makes the manifold 52a to generate an absorbing force to absorb the generated ozone from the ozone generator 41 into the flow channel 51a. The generated ozone is mixed into the discharging water to generate ozone water, and the ozone water is subsequently outputted from the sensor faucet 1.

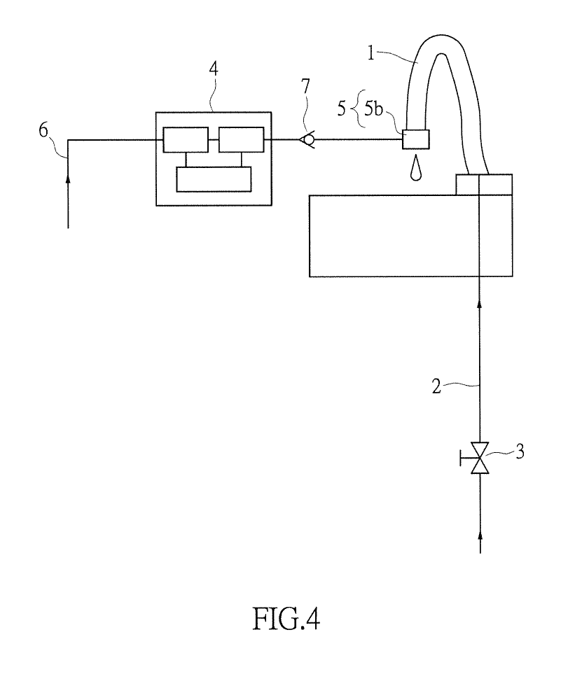

Please refer to FIG. 4, which shows a schematic diagram of the automatic ozone water outlet device of the second embodiment. The difference in the second embodiment is that the negative pressure mixing element S is a nozzle head 5b surroundingly installed on the open end of the sensor faucet 1.

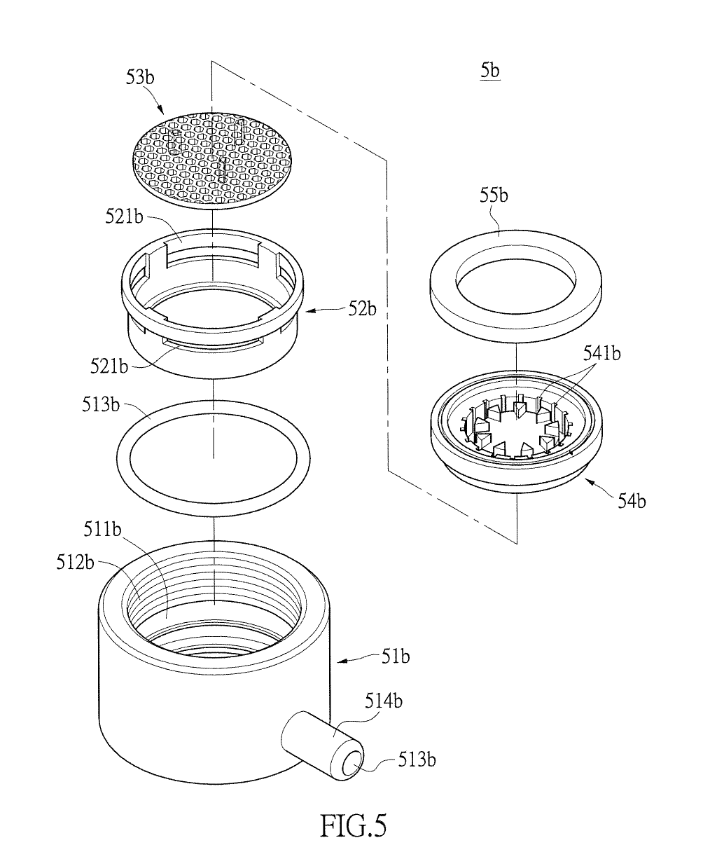

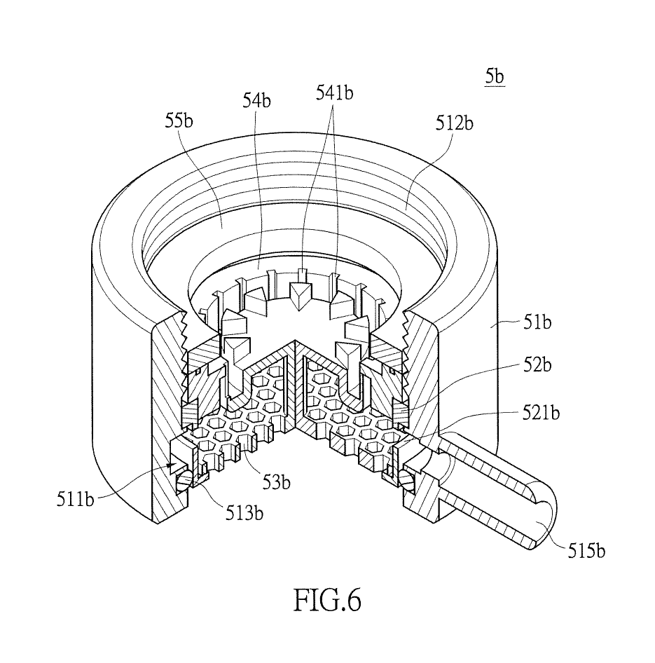

Please refer to FIGS. 5 and 6. In this embodiment, the nozzle head 5b includes a hollow body 51b, a supporting ring 52b, a porous member 53b, an adjusting ring 54b, and a waterstop gasket 55b. Concretely speaking, the hollow body 51b has an annular groove 511b formed therein and a thread surface 512b positioned above the annular groove 511b for locking on the open end of the sensor faucet 1. The hollow body 51b further includes an annular seal 513b disposed near the bottom end and an intake structure 514b extended form the outer wall thereof, wherein the intake structure 514b has an inflow channel 515b in communication with the annular groove 511b. Moreover, the intake structure 514b is in connection with the ozone generating assembly 4 through the air inlet pipe 6, preferably, an antioxidant pipe.

The supporting ring 52b is fittingly arranged within the hollow body 51b and has a plurality of vent holes 521b in correspondence with the annular groove 511b of the hollow body 51b. Thereby, the generated ozone can flow through the annular groove 511b and the vent holes 521b in order and subsequently mix into the discharging water to generate ozone water. The porous member 53b is arranged coxially within the supporting ring 52b and fixed to the bottom end of the supporting ring 52b.

The adjusting ring 54b is fittingly arranged within the hollow body 51b and coxially stacked on the supporting ring 52b. Specially, the adjusting ring 54b has a plurality of flow channels 541b at small distance intervals, and the width of each of the flow channels 541b is narrower than the opening of the sensor faucet 1. Thereby, negative pressure is created at the annular groove 511b of the hollow body 51b to absorb the generated ozone into the nozzle head 5b when water flows through the flow channels 541b of the adjusting ring 54b. The waterstop gasket 55b is coxially stacked on the adjusting ring 54b to prevent the outflow of water through the edge of the open end of the sensor faucet 1.

The descriptions illustrated supra set forth simply the preferred embodiments of the present invention; however, the characteristics of the present invention are by no means restricted thereto. All changes, alternations, or modifications conveniently considered by those skilled in the art are deemed to be encompassed within the scope of the present invention delineated by the following claims.

What is claimed is:

1. A ozone water output device, comprising:
a water supply system connected to a water source;
a negative pressure mixing element having at least one flow channel, installed on the water supply system; and
an ozone generating assembly having a sound sensor and an ozone generator, wherein the sound sensor is in connection with an air source for detecting a sound level of airflow, one end of the ozone generator is in connection with the sound sensor, the other end of the ozone generator is in connection with the negative pressure mixing element;
wherein the negative pressure mixing element is configured in such a way that when water flows through the flow channel, negative pressure is generated to produce an absorbing force to mix ozone into water.

2. The ozone water output device according to claim 1, wherein the sound sensor has an air inlet formed thereon for connection with the air source through an air inlet pipe, an air outlet away from the air inlet for connection with the ozone generator, an air channel between the air inlet and the air outlet, and a sound sensing element detachably arranged on one side of the air channel.

3. The ozone water output device according to claim 2, wherein the ozone generator has an air inlet formed thereon for connection with the air outlet of the sound sensor, an air outlet away from the air inlet for connection with the negative pressure mixing element.

4. The ozone water output device according to claim 1, further comprising a microchip controller electrically connected to the sound sensor and the ozone generator for activating the ozone generator to start generating ozone according the sound level detected by the sound sensor.

5. The ozone water output device according to claim 1, wherein the water supply system includes at least a water inlet pipe connected to the water source and a sensor faucet in connection with the water inlet pipe, the negative pressure mixing element is disposed on the water inlet pipe.

6. The ozone water output device according to claim 5, wherein the negative pressure mixing element has a flow channel and a manifold, both ends of the flow channel are wide and the middle portion of the flow channel is relatively narrow, the manifold is extended from the narrow middle portion and in connection with the air outlet of the ozone generator.

7. The ozone water output device according to claim 1, wherein the water supply system includes at least a water inlet pipe connected to the water source and a sensor faucet in connection with the water inlet pipe, the negative pressure mixing element is surroundingly installed on the open end of the sensor faucet.

8. The ozone water output device according to claim 7, the negative pressure mixing element includes a hollow body, a supporting ring, a porous member, an adjusting ring, and a waterstop gasket, the hollow body has an annular groove formed therein, the supporting ring is fittingly arranged within the hollow body and has a plurality of vent holes in correspondence with the annular groove of the hollow body, the porous member is arranged coxially within the supporting ring and fixed to the bottom end of the supporting ring, the adjusting ring is fittingly arranged within the hollow body and coxially stacked on the supporting ring, the waterstop gasket is coxially stacked on the adjusting ring.

9. The ozone water output device according to claim 8, wherein the hollow body includes an intake structure extended form the outer wall thereof and in connection with the negative pressure mixing element, the intake structure has an inflow channel in communication with the annular groove.

10. The ozone water output device according to claim 8, wherein the adjusting ring has a plurality of flow channels formed thereon, the width of each of the flow channels is narrower than the opening of the sensor faucet.
